(19) United States
(12) Patent Application Publication
(10) Pub. No.: US 2009/0302568 A1
(43) Pub. Date: Dec. 10, 2009

(54) BICYCLE HEAD SET AND BUSH THEREOF

(76) Inventor: Wen-Feng Tsai, Taichung Hsien (TW)

Correspondence Address: Chien-Hui Su, P. O. Box 70-121 Taichung, Taichung City, 40899, TW

(21) Appl. No.: 12/135,203

(22) Filed: Jun. 8, 2008

(51) Int. Cl. B62K 21/06; F16L 5/00

(52) U.S. Cl. 280/279; 16/2.1

(57) ABSTRACT

A bicycle head set includes a first ring having an outer periphery secured to an inner periphery of a head tube of the bicycle. A bush is rotatably and horizontally mounted within the first ring. The bush has a ring structure with an outer annular side and an inner annular side, wherein at least one of the outer annular side and the inner annular side has a self-lubricating layer applied thereon for use as a rotating medium of the head set. A buckling ring is mounted to the bush. The buckling ring has an inner resisting surface securely surround a steering tube of the bicycle and an outer contact surface contacting with the inner annular side of the bush.

### BACKGROUND OF THE INVENTION

1. Field of the Invention

The present invention relates to a bicycle head set, and more particularly to a bicycle head set that uses a bush to replace the conventional bearing.

2. Description of Related Art

A conventional steering bearing assembly for bicycle in accordance with the prior art approximately comprises a head tube and a steering tube assembled through an upper bearing assembly and a lower bearing assembly respectively. The upper bearing assembly and the lower bearing assembly tightly resists against the bicycle head tube through a race. The connection of the upper bearing assembly, the lower bearing assembly and the steering tube is through the gripping by an annular compression ring. For the purpose of the axial rotation between the head tube and the steering tube through the upper bearing assembly and the lower bearing assembly, there are rollers arranged between the upper bearing assembly, the lower bearing assembly and the race.

The conventional bearing assemblies can provide and axial rotation of the bicycle head tube and the steering tube, but it is not a good solution for lightening of a bicycle because of the medium of the rollers. Another prior medium of the axial rotation is a bearing. The bearing seems like a one-piece round ring, but it is assembled by rollers between two round rings for performing the axial rotation. Thus, the bearing of the rotation medium is also not beneficial for the lightening of a bicycle.

The present invention has arisen to mitigate and/or obviate the disadvantages of the conventional steering bearing assemblies.

### SUMMARY OF THE INVENTION

The main objective of the present invention is to provide an improved bicycle head set and bush thereof, wherein the bush has a self-lubricating layer adhered thereon for replacing the conventional rollers and bearings in the bicycle head set.

To achieve the objective, the bicycle head set in accordance with the present invention comprises a first ring having an outer periphery secured to an inner periphery of a head tube of the bicycle. A bush is rotatably and horizontally mounted within the first ring. The bush has a ring structure with an outer annular side and an inner annular side, wherein at least one of the outer annular side and the inner annular side has a self-lubricating layer applied thereon for use as a rotating medium of the head set. A buckling ring is mounted to the bush. The buckling ring has an inner resisting surface securely surround a steering tube of the bicycle and an outer contact surface contacting with the inner annular side of the bush.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a bicycle head set in accordance with the present invention;

FIG. 2A is a cross-sectional view of a second ring of the bicycle head set on the present invention along line 2A-2A in FIG. 1;

FIG. 2B is a cross-sectional view of a buckling ring of the bicycle head set of the present invention along line 2B-2B in FIG. 1;

FIG. 2C is a cross-sectional view of a bush of the bicycle head set of the present invention along line 2C-2C in FIG. 1;

FIG. 2D is a cross-sectional view of a first ring of the bicycle head set of the present invention along line 2D-2D in FIG. 1;

FIG. 3 is a cross-sectional view of the bicycle head set in accordance with the present invention;

FIG. 4 is a schematic view of the bicycle head set in accordance with the present invention;

FIG. 5 is a cross-sectional view of a second embodiment of the bush of the present invention;

FIG. 6 is a cross-sectional view of a third embodiment of the bush of the present invention;

FIG. 7 is a cross-sectional view of a fourth embodiment of the bush of the present invention;

FIG. 8 is a cross-sectional view of a fifth embodiment of the bush of the present invention; and

FIG. 9 is a cross-sectional view of a sixth embodiment of the bush of the present invention.

### DETAILED DESCRIPTION OF THE INVENTION

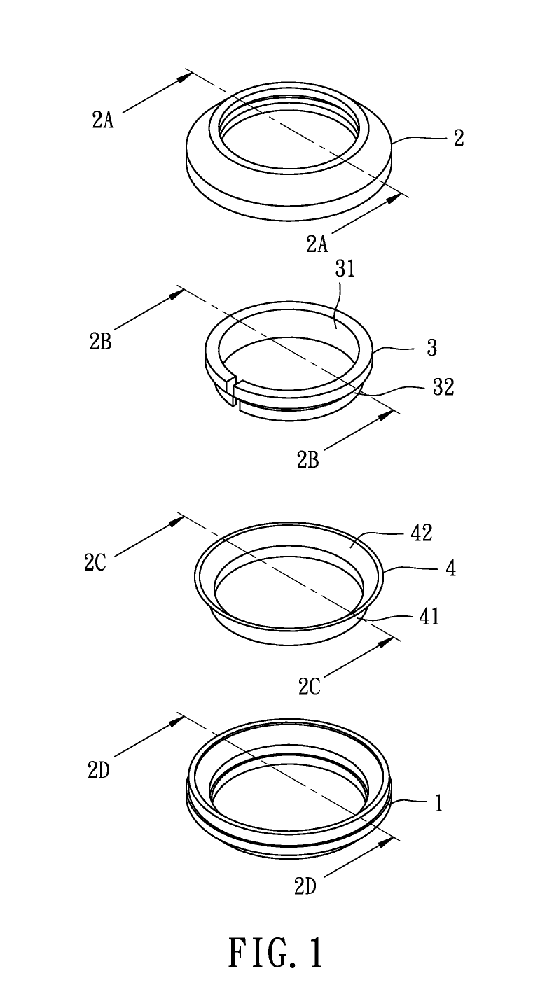

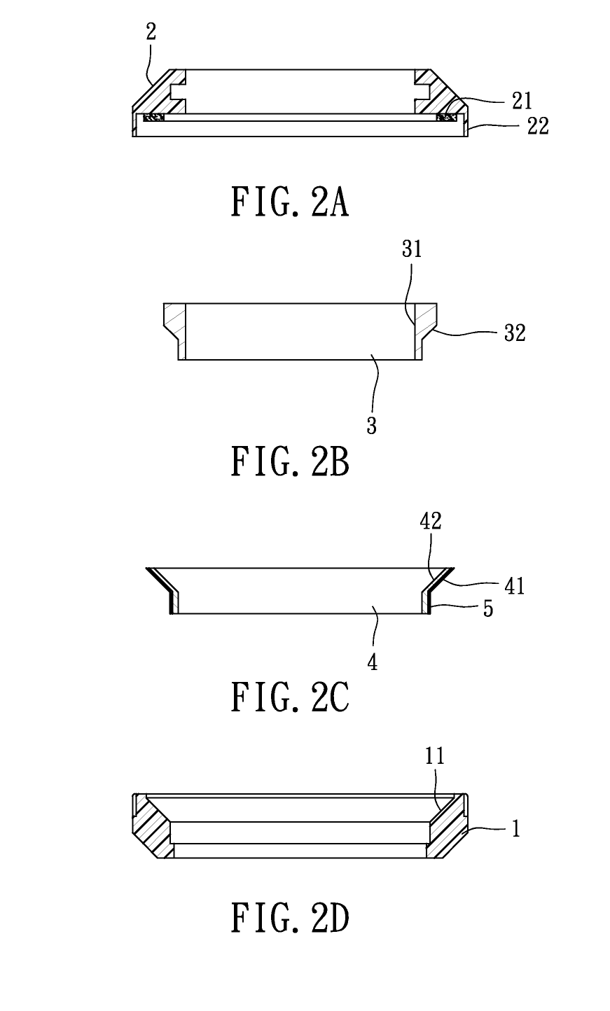

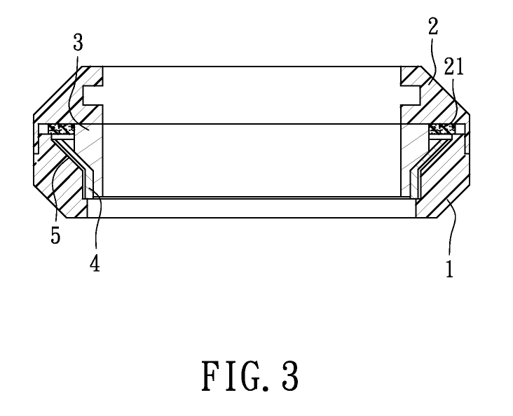

Referring to the drawings and initially to FIGS. 1-3, a head set in accordance with the present invention comprises a first ring (1), a bush (4), a buckling ring (3) and a second ring (2) sequentially concentrically mounted to one another.

The first ring (1) has an inner side (11) that is curved or slanted. In the preferred embodiment of the present invention, the interior side (11) of the first ring (1) is slanted. The first ring (1) includes an outer periphery adapted to be secured to an inner periphery of a head tube of the bicycle.

The bush (4) is rotatably and horizontally mounted within the first ring (1). The bush (4) includes an outer annular side (41) and an inner annular side (42) respectively formed thereon. A self-lubricating layer (5) is adhered to the outer annular side (41). The self-lubricating layer (5) is made of macromolecule material, such as polytetrafluoroethene (PTFE). The self-lubricating layer (5) slidably abuts against the inner side (11).

The buckling ring (3) is mounted to the bush (4). The buckling ring (3) has an inner resisting surface (31) adapted to securely surround a steering tube of the bicycle and an outer contact surface (32) contacting with the inner annular side (42) of the bush (4). In the preferred embodiment of the present invention, the buckling ring (3) is a C-shaped ring.

The second ring (2) is rotatably mounted to a top of the first ring (1) for holding the bush (4) and the buckling ring (3) in place. A washer (21) is sandwiched between the first ring (1) and the second ring (2) for water-proof and anti-dust. The second ring (2) has a skirt (22) extending from an outer periphery of the second ring (2) for surrounding the top portion of the first ring (1).

The contract portions of the outer annular side (41) of the bush (4) and the inner side (11) of the first ring (1) are respectively formed with an inclined surface. In addition, the contract portions of the inner annular side (42) of the bush (4) and the contract surface (32) of the buckling ring (3) are respectively formed with an inclined surface. As a result, the contract areas between the bush (4) and the first ring (1), and between the bush (4) and the buckling ring (3) are enlarged.

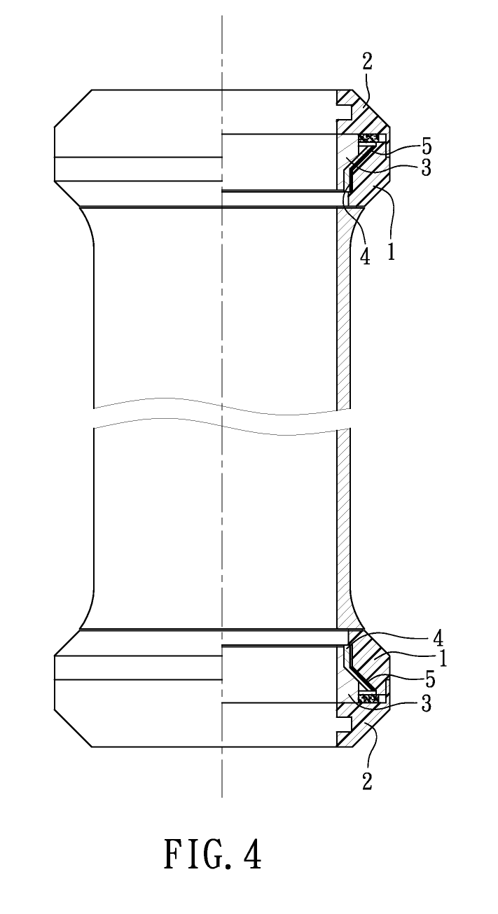

With reference to FIG. 4, for assembling the head set in accordance with the present invention, the buckling ring (3) is adapted to be securely surrounded the steering tube of the bicycle and the first ring (1) is adapted to be securely resisting with the inner periphery of the head tube of the bicycle such that the buckling ring (3), and the self-lubricating layer (5) between the first ring (1) and the bush (4) are used as rotation medium between the head tube and the steering tube of the bicycle due to the material characteristic of the self-lubricating layer (5).

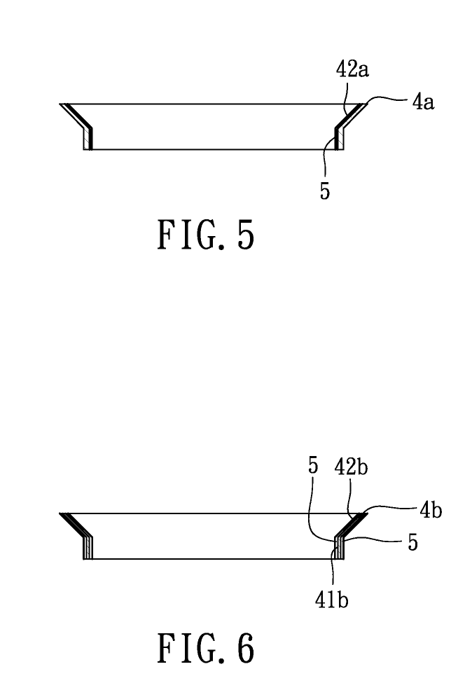

With reference to FIG. 5 that shows a second embodiment of the bush (4a) in accordance with the present invention, the bush (4a) in accordance with the present invention has a ring structure and a self-lubricating layer (5) applied to an inner annular side (42a) thereof. In addition, the buckling ring (3) is securely surrounding the steering tube of the bicycle such that the self-lubricating layer (5) is used as a bearing or rollers, in a conventional head set, for providing a smooth operation.

In addition, as shown in FIG. 6 that shows a third embodiment of the bush (4b) in accordance with the present invention, the outer annular side (41b) and the inner annular side (42b) of the bush (4b) respectively have a self-lubricating layer (5) applied thereon for providing a smooth operation to the head set of the bicycle.

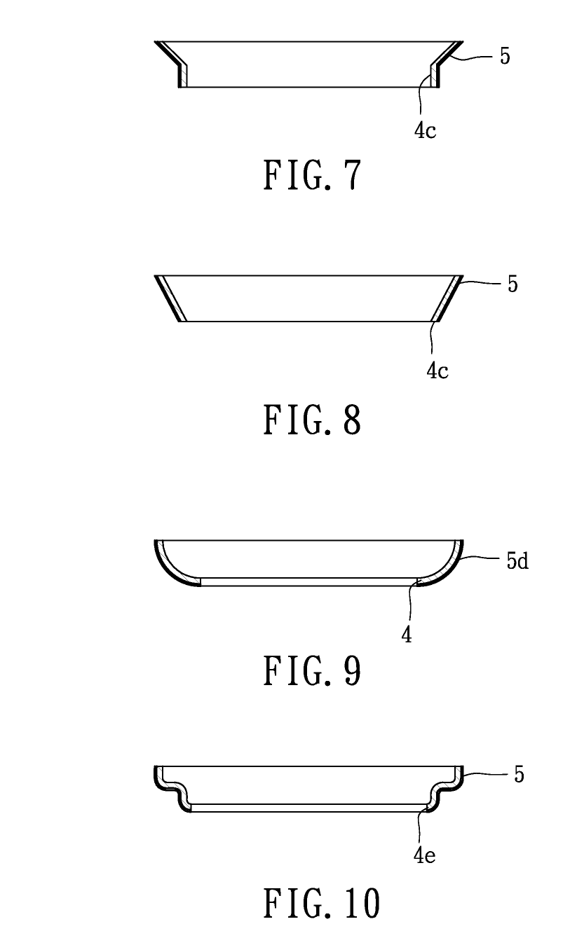

As shown in FIG. 7 that shows a fourth embodiment of the bush (4c) in accordance with the present invention, in this embodiment, the bush (4c) has a tapered cross-section.

As shown in FIG. 8 that shows a fifth embodiment of the bush (4d) in accordance with the present invention, in this embodiment, the bush (4d) has a curved cross-section.

As shown in FIG. 9 that shows a fifth embodiment of the bush (4e) in accordance with the present invention, in this embodiment, the bush (4e) has a stepped cross-section.

Although the invention has been explained in relation to its preferred embodiment, it is to be understood that many other possible modifications and variations can be made without departing from the spirit and scope of the invention as hereinafter claimed.

What is claimed is:

1. A bush for a bicycle head set, comprising a ring structure with an outer annular side and an inner annular side, wherein at least one of the outer annular side and the inner annular side has a self-lubricating layer applied thereon for use as a rotating medium of the head set.

2. The bush as claimed in claim 1, wherein the self-lubricating layer is applied on the inner annular side.

3. The bush as claimed in claim 1, wherein the self-lubricating layer is applied on the outer annular side.

4. The bush as claimed in claim 1, wherein the bush has a tapered cross-section.

5. The bush as claimed in claim 1, wherein the bush has a curved cross-section.

6. The bush as claimed in claim 1, wherein the bush has a stepped cross-section.

7. The bush as claimed in claim 2, wherein the bush has a tapered cross-section.

8. The bush as claimed in claim 2, wherein the bush has a curved cross-section.

9. The bush as claimed in claim 2, wherein the bush has a stepped cross-section.

10. The bush as claimed in claim 3, wherein the bush has a tapered cross-section.

11. The bush as claimed in claim 3, wherein the bush has a curved cross-section.

12. The bush as claimed in claim 3, wherein the bush has a stepped cross-section.

13. A bicycle head set comprising:
a first ring having an outer periphery adapted to be secured to an inner periphery of a head tube of the bicycle;
a bush rotatably and horizontally mounted within the first ring, the bush having a ring structure with an outer annular side and an inner annular side, wherein at least one of the outer annular side and the inner annular side has a self-lubricating layer applied thereon for use as a rotating medium of the head set; and
a buckling ring mounted to the bush, the buckling ring having an inner resisting surface adapted to securely surround a steering tube of the bicycle and an outer contact surface contacting with the inner annular side of the bush.

14. The bicycle head set as claimed in claim 13 further comprising a second ring rotatably mounted to a top of the first ring for holding the bush and the buckling ring in place and a washer sandwiched between the first ring and the second ring for water-proof and anti-dust.

15. The bicycle head set as claimed in claim 14, wherein the second ring has a skirt extending from an outer periphery of the second ring for surrounding the top portion of the first ring.
